(19) United States
(12) Patent Application Publication
(10) Pub. No.: US 2013/0119039 A1
(43) Pub. Date: May 16, 2013

(54) EDUCATIONAL WELDING CELL UNIT

(71) Applicant: David E. OSICKI, Painesville, OH (US)

(72) Inventor: David E. OSICKI, Painesville, OH (US)

(73) Assignee: Lincoln Global, Inc., City of Industry, CA (US)

(21) Appl. No.: 13/294,655

(22) Filed: Nov. 11, 2011

(51) Int. Cl. B23K 9/00

(52) U.S. Cl. 219/136

(57) ABSTRACT

A welding cell unit includes a frame and a cell table that supports a robotic welding system, the cell table is attached to the frame. A table top is pivotally secured to the cell table, the table top is rotated outwardly from a non-extended position adjacent a side of the cell table into an extended position coextensive with a table top plane. A support mechanism structurally supports the table top when in an extended position. A plurality of panels surround the cell table, the plurality of panels are configured to extend outwardly from the cell table to enclose the table top when in an extended position.

### TECHNICAL FIELD

The present disclosure is related to cell enclosures, and more particularly, to features that temporarily enlarge the volume of welding cell units to allow greater range of motion to articulate a robot welding system.

### BACKGROUND OF THE INVENTION

Welding systems are commonly used with robots to accurately and repeatedly weld components together. Such robotic welding systems are generally disposed within a cell enclosure to safely contain a welding operation and to protect users that may be observing the process. Typically, the robotic welding system includes a robot arm with a welding torch that is used to weld a work piece positioned on a work table within the cell enclosure. The robot is programmed to weld along a desired path commensurate with each particular weld type. Due to spatial constraints, robots have a restricted movement within the cell enclosure, wherein complex and/or wide path weld processes cannot be executed. This problem is exacerbated when the robot is within a portable cell enclosure, which has a relatively narrow width, thereby further limiting the footprint and associated range of motion. Improved systems and methods are needed to overcome these and other deficiencies.

### SUMMARY OF THE INVENTION

In one aspect, a welding cell unit includes a frame and a cell table that supports a robotic welding system, the cell table is attached to the frame. A table top is pivotally secured to the cell table, the table top is rotated outwardly from a non-extended position adjacent a side of the cell table into an extended position coextensive with a table top plane. A support mechanism structurally supports the table top when in an extended position. A plurality of panels surround the cell table, the plurality of panels are configured to extend outwardly from the cell table to enclose the table top when in an extended position.

In another aspect, a welding cell unit includes a frame and a cell table that supports a robotic welding system, the cell table is secured to the frame. A first table top is pivotally secured to the cell table, the first table top is rotated outwardly from a non-extended position adjacent a side of the cell table in a first direction into an extended position coextensive with a table top plane. A second table top is pivotally secured to the cell table, the second table top is rotated outwardly from a non-extended position adjacent a side of the cell table in a second direction into an extended position coextensive with the table top plane, the second direction is opposite the first direction, the second direction is opposite the first direction. A first support mechanism structurally supports the first table top when in an extended position and a second support mechanism structurally supports the second table top when in an extended position. A plurality of panels surround the cell table, the plurality of panels are configured to extend outwardly in both the first direction and the second direction from the cell table to enclose the first table top and the second table top when in an extended position.

In yet another aspect, a welding cell unit includes a frame and means for supporting a robotic welding system, which is coupled to the frame. Means are employed to pivotally secure a table top to support the robotic welding system, wherein the table top is rotated outwardly from a non-extended position adjacent a side of the cell table into an extended position coextensive with a table top plane. Means are utilized to support the table top when in an extended position. Means are also employed to outwardly extend a plurality of panels to enclose the table top when in an extended position.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Reference is made to the accompanying drawings in which particular embodiments and further benefits of the invention are illustrated as described in more detail in the description below, in which:

FIG. 1 is a front elevation view of a welding cell unit that includes an expansion table;

FIG. 2 is a side elevation view of a welding cell unit that illustrates an expansion table with a fold-up tabletop and fold-out panels;

FIG. 3 is a top plan view of a welding cell unit that includes an expansion table and panels for enclosure thereof;

FIG. 4 is a perspective view of a welding cell unit that shows a first expansion table extended from a left side;

FIG. 5 is a perspective view of a welding cell unit that illustrates a second expansion table extended from a right side;

FIG. 6 is a perspective view of a welding cell unit with an expansion table extended from the left side, wherein the welding cell unit has a welding robot disposed therein; and

FIG. 7 is a perspective view of the welding cell unit in FIG. 6 with an expansion table extended from a right side.

### DETAILED DESCRIPTION OF THE INVENTION

Referring now to the figures, several embodiments or implementations of the present invention are hereinafter described in conjunction with the drawings, wherein like reference numerals are used to refer to like elements throughout. The present disclosure is related to welding cell enclosures that includes an expansion table to temporarily enlarge volume of a welding cell unit to allow greater range of motion for a robot welding system. Although illustrated and described hereinafter in the context of various exemplary welding systems, the invention is not limited to the illustrated examples.

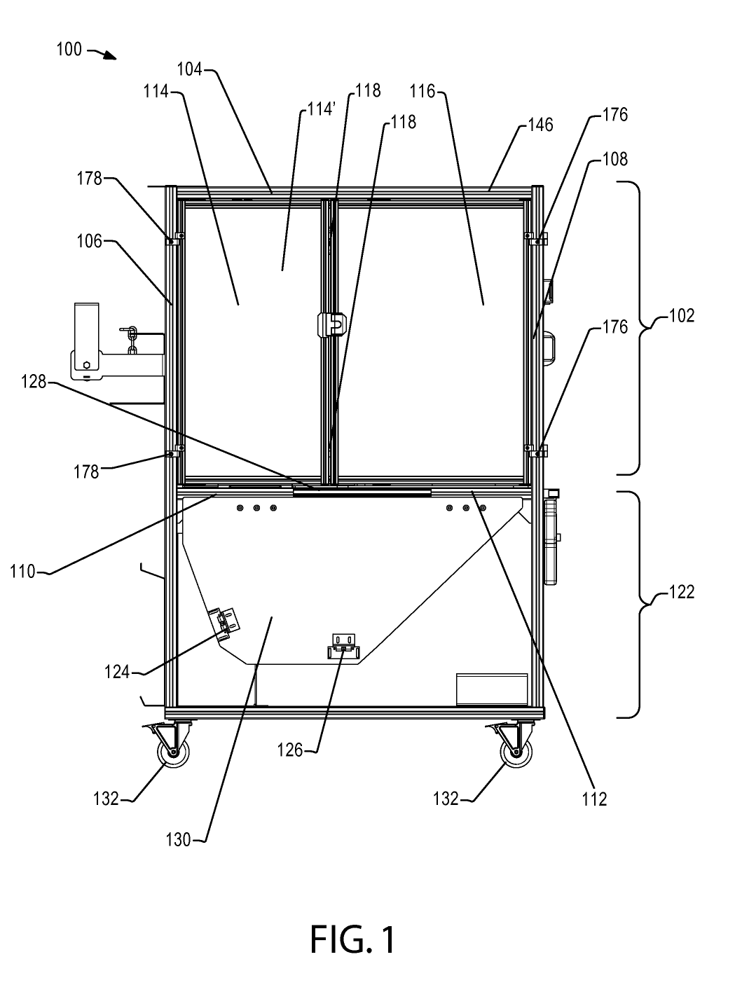

With reference to FIG. 1, welding cell unit 100 includes a cell enclosure 102 disposed on top of a cart 122. The cell enclosure 102 includes a frame 146 that includes a plurality of panels that extend around the periphery of a cell table (not shown) used to support a robotic welding system for welding one or more workpieces. The panels within the frame 146 can be adjusted to modify the size of the volume of the welding cell unit to accommodate articulation of the robotic welding system. The frame 146 includes a top panel rail 104 supported on distal ends by upright supports 106 and 108, which extend upwardly from a table support 128. The supports include an access door 114 and a bifold panel 114′, which is folded behind the access door 114, which are all disposed coextensive with a panel plane. A user can slide the access door 114/bifold panel 114′ combination toward the access panel 116 to gain access to the cell table. The access door 114, bifold panel 114′, and access panel 116, are all disposed between the top panel rail 104 and the table support 128 within channels, grooves, or other means to facilitate lateral movement of the access door therein. For this purpose, the frame 146 can be comprised of aluminum profile components. Wheels 132 are employed to facilitate transport of the welding cell unit 100 from location to location.

A table top 130 is pivotally secured to the table support 128 via a table hinge 110 and a table hinge 112. The hinges 110, 112 allow the table top 130 to swing outwardly to a position that is substantially orthogonal to the side of the welding cell unit 100, wherein it is supported by one or more supporting members (not shown). In this manner the table top 130 extends from the cell table to form an augmented platform coextensive with a table top plane, which substantially orthogonal to the panel plane. Once the table top is extended into position, the access door 114, bifold panel 114′, and access panel 116 can be outwardly extended to enclose the periphery of the table top 130 thereby forming a continuous enclosure around the exterior of the welding cell unit 100. The access door 114, bifold panel 114′, and access panel 116 can all be coupled together to facilitate such outward extension. In an embodiment, the access door 114 and bifold panel 114′ are coupled together in a bi-fold arrangement, wherein the bifold panel 114′ is folded out and positioned between the access door 114 and the access panel 116 to form a three-sided wall. A hinge set 178 can couple the upright support 106 to the access door 114; a hinge set 118 can couple the access door 114 to the bifold panel 114′; a hinge set (not shown) can couple the bifold panel 114′ to the access panel 116; and a hinge set 176 can couple the access panel 116 to the upright support 108.

The table top 130 includes at least one securement means illustrated in FIG. 1 as a securement 124 and a securement 126, which are employed to accommodate the access door 114 and bifold panel 114′ respectively when the expansion table is extended from the welding cell unit. In FIG. 1, the securements 124, 126 are a clamping mechanism or other suitable apparatus utilized to hold a bottom portion of the panels to the table top 130 when placed in an extended position. By extending and retracting the table top 130, the welding cell unit can be transported through doorways within a building. In an example, the welding cell unit 100 is in an operational state when extended (e.g., in a classroom) and returned to a non-extended position for transport therefrom. Accordingly, the subject embodiments facilitate portability of the welding cell unit to allow audiences in different locations to view the robotic welding system in operation.

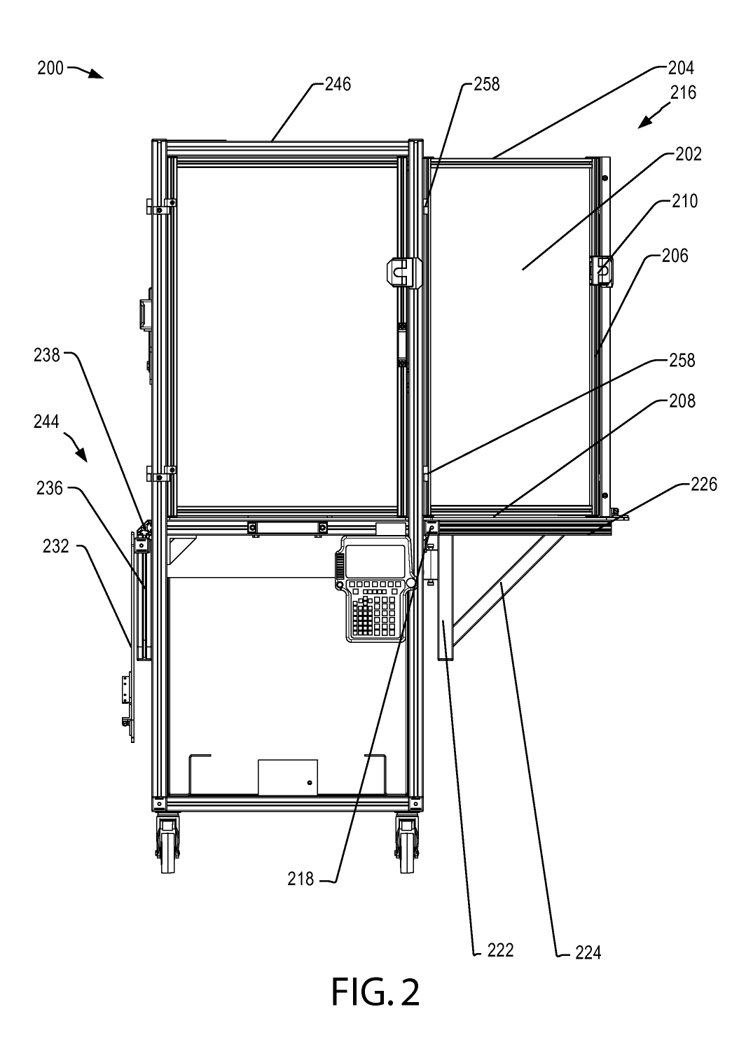

FIG. 2 is a side elevation view of the welding cell unit of FIG. 1, now renumbered as 200 that illustrates the unit with a first expansion table 216 in an extended position and a second expansion table 244 in a non-extended position. The first expansion table 216 includes a side panel 202 which is coupled to one or more other panels to form a continuous enclosure surrounding the periphery of a table top 226. The side panel 202 is framed via a top panel rail 204, a side panel rail 206 and a bottom panel rail 208. This frame can accommodate the side panel 202 wherein each frame member includes a slot or other means to hold an edge of the side panel 202 in place to prohibit a direct line of sight from an outside observer to a weld operation executed within the welding cell unit 200. In an embodiment, the side panel 202 is the access door 114 and is made of a transparent material, which blocks particular light frequencies to prevent damage to an observer's eyes or other deleterious effects.

As shown, when the expansion table 216 is in an extended position, the table top 226 is rotated outwardly away from the welding cell unit 200, wherein such rotation is facilitated via a hinge 218. Once the table top has been extended to an appropriate location, a retractable support system is extended into place to allow the table top 226 to bear a load, such as a workpiece. In an embodiment, the retractable support system includes an upright table support 222 which is coupled to a bottom surface of the table top 226 via a table angle bracket 224. The side panel 202 is coupled to the welding cell unit via hinges 258.

The second expansion table 244 includes a table top 232, which is coupled to the welding cell unit 200 via a hinge 238. When the expansion table 244 is in an extended position, the table top 232 is rotated outwardly until it is located in a substantially orthogonal location relative to the upright members of the welding cell unit 200. At such time, a retractable support system 236 is extended underneath the table top 232 to provide structural support. Subsequently, a plurality of panels are extended outwardly commensurate with the size of the table top 232 to provide a continuous enclosure of the table top 232, which extends from the welding cell unit 200. The table tops 226, 232 and support systems can be made of any suitable material being sufficient structural strength to support materials thereupon, including steel, stainless steel, aluminum, and plastic.

Once the robotic weld operation is complete, one or both of the expansion tables 216, 244 can be returned to a non-extended position wherein the cell unit 200 is transported to new location. In the non-extended position, the width of the welding cell unit 200 can be sized to allow transport of the welding cell unit 200 through a standard sized doorway. In an embodiment, the width of the welding cell unit 200 is between 25 and 40 inches. In another embodiment, the width is between 30 and 35 inches. In another embodiment, the width is between 32 and 34 inches, although both smaller and larger dimensions are within the scope of this invention.

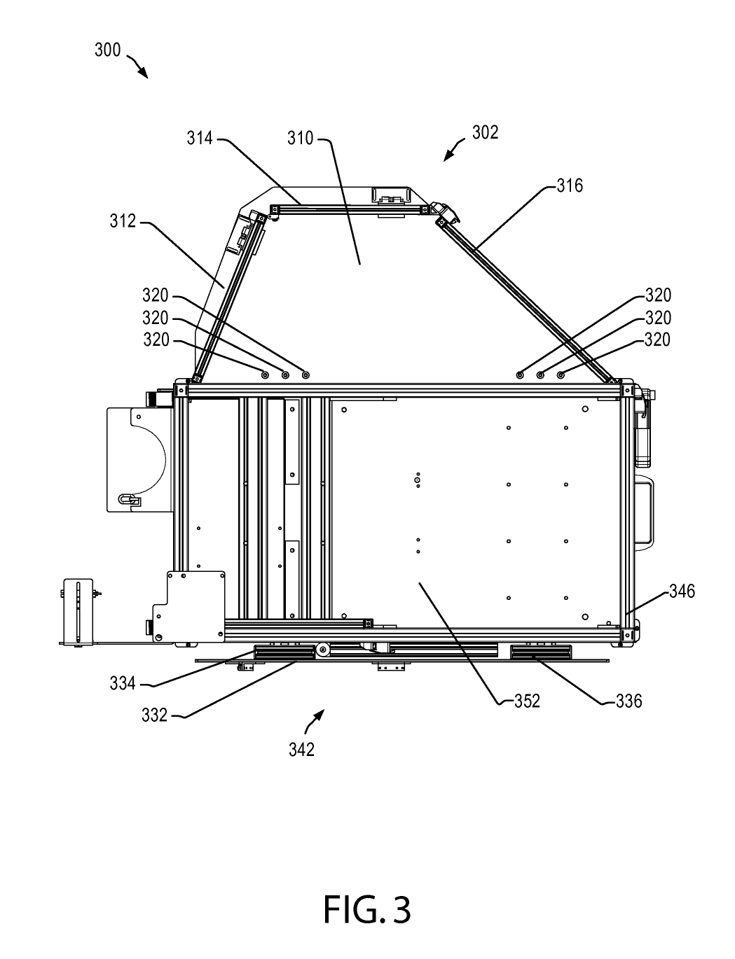

FIG. 3 is a plan view of a welding cell unit of FIG. 1, now renumbered as 300 that includes a cell table 352 and a first expansion table 302 in an extended position to augment the footprint of the cell table 352 for additional area to facilitate enhanced movement of a robotic welding system. In this embodiment, the welding cell unit 300 also includes a second expansion table 342, which is shown in a non-extended position. The first expansion table 302 includes a table top 310 which is surrounded by a side panel 312, a center panel 314 and a side panel 316, which are employed to form a continuous enclosure around the table top 310 from the cell table 352. In an embodiment, the side panel 312, center panel 314, and side panel 316 are access door 114, bifold panel 114′ and access panel 116 respectively, as shown in FIG. 1. The table top 310 is coupled to a hinge set (not shown) via a plurality of fasteners 320. The fasteners 320 can be substantially any fastening element, such as a rivet, screw, bolt or other suitable fastening means.

The second expansion table 342 shown in its folded position includes a table top 332 coupled to the welding cell unit 300 via hinges 334, 336. In order to place the second expansion table 342 into an extended position, the table top 332 is extended outwardly from the welding cell unit 300 wherein a retractable support is extended underneath the table top for subsequent use. In this manner, both table tops 310, 332 can be extended from cell table 352 to increase the footprint of the welding cell unit by two to three fold or more. The additional space can allow a plurality of workpieces to be welded by a robotic welding system in single operation. Alternatively or in addition, the robotic welding system can be programmed to follow a complex and/or large range of motion to demonstrate a multitude of capabilities to a viewing audience.

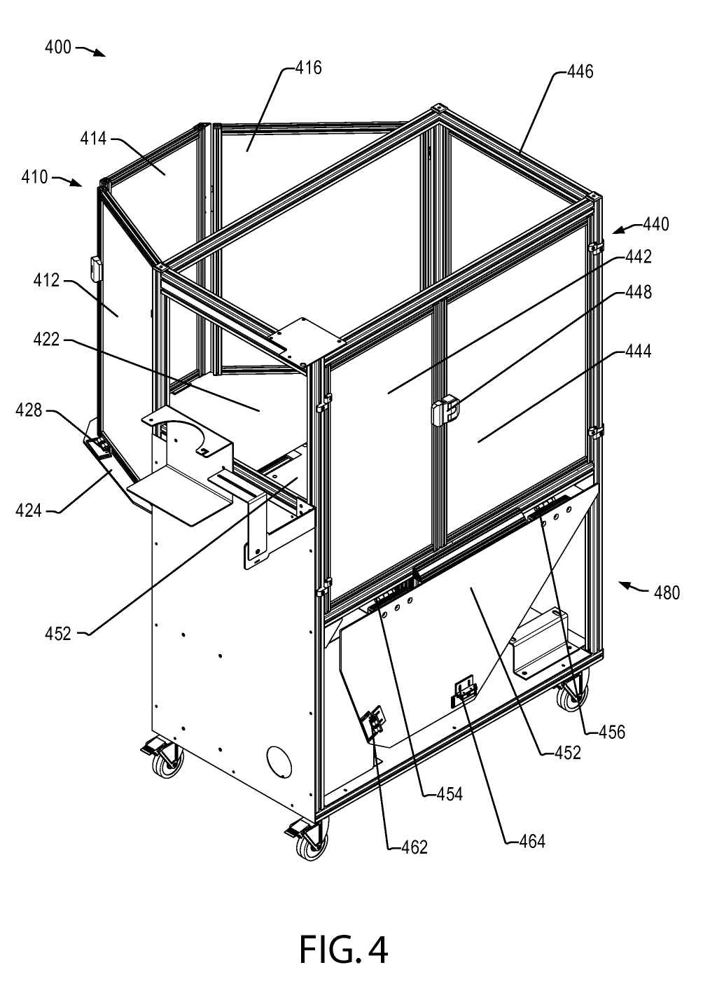

FIG. 4 is a left side perspective view of a welding cell unit of FIG. 1, now renumbered 400 which includes a first expansion table 410 and a second expansion table 460 that extend from a cell table 452. As shown, the first expansion table 410 is in an extended position and the second expansion table 460 is in a non-extended position. The expansion table 410 includes a table top 422 which is surrounded by a side panel 412, a center panel 414, and a side panel 416. One or more hinge sets can be employed to couple each of the side panel 412, center panel 414, and the side panel 416 to one another and to the welding cell unit 400. Such hinging mechanism (or other suitable device) can allow the panels to be moved into substantially any form to surround the table top 422. Alternatively or in addition, a greater number of panels than shown can be employed to facilitate a larger-sized footprint and/or different shape of the table top 422, thereby providing a greater range of motion for the robotic weld system. One or more securements, such as securement 428, is employed to couple each panel to the table top 422.

The second expansion table 460 includes a table top 452 that is coupled to the welding cell unit 400 via a table hinge 454 and a table hinge 456. When the table top 452 is in an extended position, an access side 440 is extended from the frame of the welding cell unit 400 to enclose the periphery of the table top 452. The access side 440 includes an access door 442 which facilitates entry into the interior of the welding cell unit 400. The access door can be opened by sliding the door toward an access panel 444 disposed adjacent thereto. A frame 446 can be comprised of a plurality of extruded segments, such as a aluminum profile extrusion or other suitable structural components, which include a plurality of grooves disposed longitudinally along the access of each structural element. Thus, the access door 442 can be disposed within such grooves to allow movement of the access door by a user. A third panel (not shown) can also be disposed behind either the access door 442 or the access panel 444 which is exposed when the access side is extended to surround the table top 452. For this purpose, a panel hinge 448 is utilized to couple the access door 442 to the access panel 444 to facilitate flexible disposition thereof.

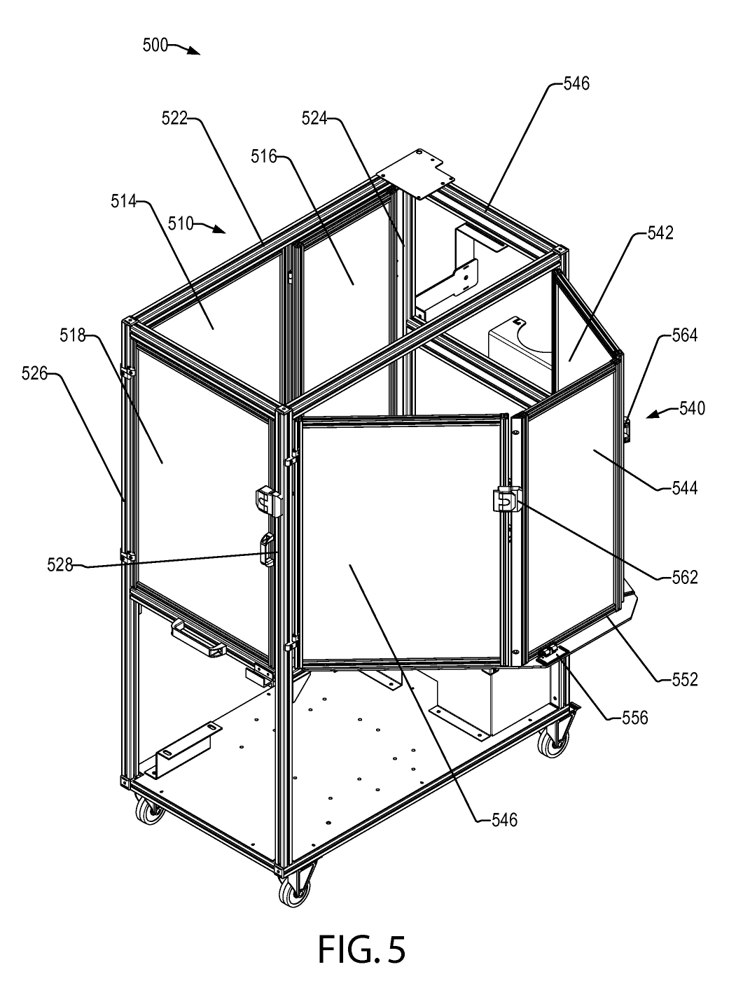

FIG. 5 is a right side perspective view of a welding cell unit of FIG. 1, now renumbered as 500, which, in an embodiment is an alternative view to the welding cell unit 400. The welding cell unit 500 includes an access side 510, which is employed to allow a user to access the interior of the welding cell unit 500 to retrieve and/or place materials to be welded and/or attend to the robotic welding system therein. An access door 516 is bi-folded against the center panel 520 and placed adjacent thereto. An access panel 514 is adjacent the access door 516 and center panel 520. Upright supports 524, 526, 528, 530 are used to support a top rail 522 which defines the interior of the welding cell unit 500. Upright supports 524 and 526 support the outside portions of the access side panels and upright support 528, 530 support the outside sections of side panels 542 and 546. A center panel 544 is disposed between the side panels 542, 546 and is coupled thereto via panel hinges 562 and 564 respectively. Securements 556, 558 are employed to couple the bottom of the panels to a table top 552 when it is disposed in an extended position.

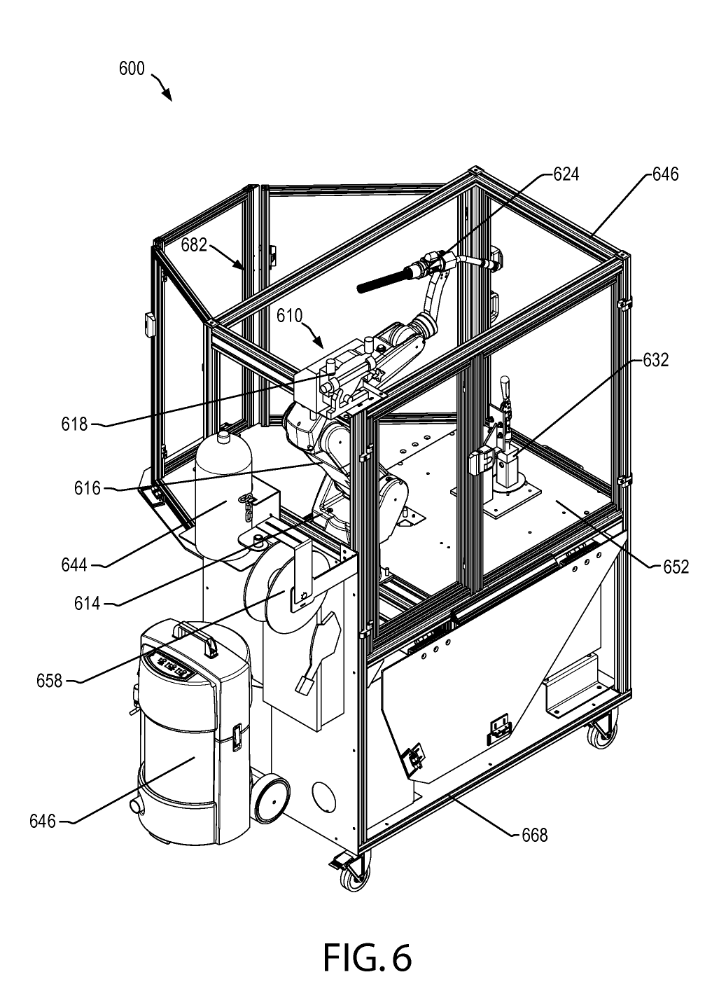

FIG. 6 illustrates a welding cell unit 600 that encloses a robot 610. The robot is disposed upon a pedestal 614, which is coupled to a body 616 and further to an arm 618 to manipulate a welding gun 624 through space. In an embodiment, the robot 610 is an ARC MATE™ robot available from FANUC Robotics America, Inc. Other similar robots can also be used. The robot 610 can be centered with respect to the area defined by the welding cell unit 600 and can include a plurality of axes of movement. If desired, the pedestal 614 can rotate to facilitate substantially 360 degrees of motion. For this purpose, a drive mechanism such as a motor and transmission (not shown) can be housed in the pedestal 614 to rotate the robot 610. Although the robot 610 is shown mounted to a lower portion of the welding cell unit, the robot can mount to an upper structure of the cell unit and depend downwardly into the cell there from.

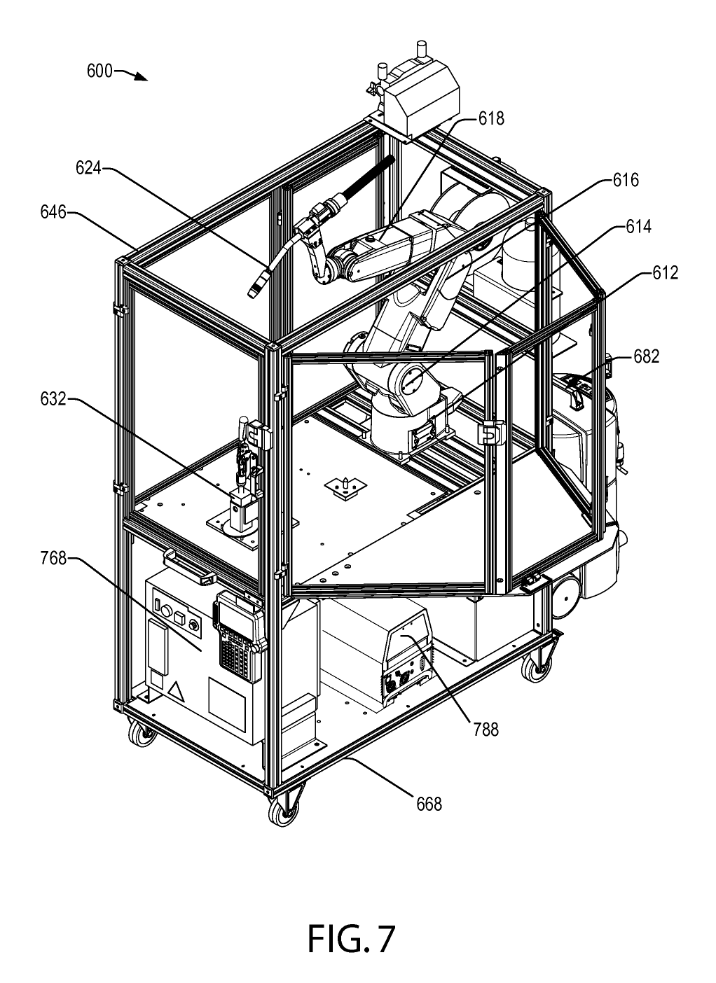

A welding gun 624 attaches to a distal end of the robot arm 618, wherein the welding gun 624 is similar to those that are known in the art. Consumable electrode wire can be stored in a container from a spool 658 and delivered to the welding gun 624 through a conduit to weld a workpiece held by a welding fixture 632. A wire feeder 622, such as a PF 10 F-II Wire Feeder available from the Lincoln Electric Company, attaches to the welding cell unit to facilitate delivery of welding wire to the welding gun 624. A gas bottle 644 can be mounted to the end of the welding cell unit 600 to deliver shielding gas to a weld location. A fume extractor 646 can be mounted or otherwise attached to the welding cell unit 600, to extract fumes from a weld site, as known in the art. Referring now to FIG. 7, a welding power supply 788 used with a welding operation mounts to and rests on a platform 668 and is connected to and can be a part of the welding cell unit 600. A robot controller 768, which controls the robot 610, also rests and mounts on the platform 668 to provide control signals to the robot 610.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

1. A welding cell unit, comprising:
a frame;
a cell table that supports a robotic welding system, the cell table attached to the frame;
a table top pivotally secured to the cell table, the table top is rotated outwardly from a non-extended position adjacent a side of the cell table into an extended position coextensive with a table top plane;
a support mechanism that structurally supports the table top when in an extended position; and
a plurality of panels that surround the cell table, the plurality of panels are configured to extend outwardly from the cell table to enclose the table top when in an extended position, and wherein the panels are disposed coextensive with a panel plane when in a non-extended position, the panel plane being substantially orthogonal to the table top plane, and further wherein one of the plurality of panels comprises:
an access door;
a bifold panel behind the access door, the panel is not visible when in its initial position; and
an access panel that is disposed in a lateral direction adjacent the access door and bifold panel,
wherein the access door and bifold panel are slid toward the access panel in a first direction to gain access to the cell table when the table top is in a non-extended position.

2. (canceled)

3. (canceled)

4. The welding cell unit according to claim 1, further including:
a frame that supports each of the plurality of panels to extend around the periphery of the table top when in an extended position, the frame includes a top panel rail that is supported on distal ends by first upright support and a second upright support, wherein the upright supports are disposed at either end of the welding cell unit.

5. The welding cell unit according to claim 4, wherein when the plurality of panels are in an extended position, the access door is hingedly coupled to the first upright support and the bifold panel, the bifold panel is hingedly coupled to the access door and the access panel, and the access panel is hingedly coupled to the bifold panel and the second upright support.

6. The welding cell unit according to claim 5, wherein the bifold panel is extended further out from the cell table than the access door and the access panel.

7. The welding cell unit according to claim 1, wherein the support mechanism includes an upright support that supports a first side of the table top and an angle bracket, coupled to the upright support, that supports a second side of the table top.

8. The welding cell unit according to claim 1, further including:
one or more securements, which mechanically couple at one of the access door, the bifold panel, and the access panel to the table top, when the table top is in an extended position.

9. The welding cell unit according to claim 1, wherein the welding cell unit is in an operational state to allow a operation of a robotic welding system when the table top is in an extended position.

10. The welding cell unit according to claim 1, wherein the welding cell unit is in a transport state to facilitate transport of the welding cell unit when the table top is in a non-extended position.

11. The welding cell unit according to claim 1, wherein the width of the welding cell unit is between 25 and 40 inches.

12. The welding cell unit according to claim 4, wherein the frame is comprised of extrusion profile elements.

13. A welding cell unit, comprising:
a frame;
a cell table that supports a robotic welding system, the cell table is secured to the frame;
a first table top pivotally secured to the cell table, the first table top is rotated outwardly from a non-extended position adjacent a side of the cell table in a first direction into an extended position coextensive with a table top plane;
a second table top pivotally secured to the cell table, the second table top is rotated outwardly from a non-extended position adjacent a side of the cell table in a second direction into an extended position coextensive with the table top plane, the second direction is opposite the first direction;
a first support mechanism that structurally supports the first table top when in an extended position;
a second support mechanism that structurally supports the second table top when in an extended position;
a plurality of panels that surround the cell table, the plurality of panels are configured to extend outwardly in both the first direction and the second direction from the cell table to enclose the first table top and the second table top when in an extended position, and wherein the panels are disposed on a first side of the welding cell unit and a second side of the welding cell unit, the panels on the first side are disposed coextensive with a first panel plane when in a non-extended position, the panels on the second side are disposed coextensive with a second panel plane when in a non-extended position, the first panel plane and the second panel plane are substantially parallel to one another and both substantially orthogonal to the table top plane, and wherein panels on the first side and panels on the second side each include:
an access door;
a bifold panel behind the access door, the bifold panel is not visible when in its initial position; and
an access panel that is disposed in a lateral direction adjacent the access door and bifold panel, and further wherein
the access door and bifold panel are slid toward the access panel in a first direction to gain access to the cell table when the table top is in a non-extended position.

14. (canceled)

15. (canceled)

16. The welding cell unit according to claim 13, further including:
a frame that supports each of the plurality of panels to extend around the periphery of the table top when in an extended position, the frame includes a top panel rail that is supported on distal ends by first upright support and a second upright support on each of the first side and the second side, wherein the upright supports are disposed at either end of the welding cell unit.

17. The welding cell unit according to claim 16, wherein when the plurality of panels are in an extended position in either the first direction or the second direction, the access door is hingeldy coupled to the first upright support and the bifold panel, the bifold panel is hingedly coupled to the access door and the access panel, and the access panel is hingedly coupled to the bifold panel and the second upright support.

18. The welding cell unit according to claim 17, wherein the bifold panel is extended further out from the cell table than the access door and the access panel.

19. The welding cell unit according to claim 13, further including a robotic welding system disposed on the cell table that articulates a welding gun through space.

20. A welding cell unit, comprising:
a frame;
means for supporting a robotic welding system, which is coupled to the frame;
means for pivotally securing a table top means for supporting the robotic welding system, the table top is rotated outwardly from a non-extended position adjacent a side of the cell table into an extended position coextensive with a table top plane;
means for supporting the table top when in an extended position; and
means for outwardly extending a plurality of panels to enclose the table top when in an extended position, and wherein
said plurality of panels comprises:
an access door;
a bifold panel behind the access door, the bifold panel is not visible when in its initial position; and
an access panel that is disposed in a lateral direction adjacent the access door and bifold panel, and further wherein
the access door and bifold panel are slid toward the access panel in a first direction to gain access to the cell table when the table top is in a non-extended position.
